(19) United States
(12) Patent Application Publication
(10) Pub. No.: US 2014/0352442 A1
(43) Pub. Date: Dec. 4, 2014

(54) Vibration Detection System Based on Biconical Tapered Fiber and the Method thereof

(71) Applicant: Macau University of Science and Technology, Taipa (MO)

(72) Inventors: Jianqing LI, Taipa (MO); Ben XU, Taipa (MO); Yuanyuan PAN, Taipa (MO)

(21) Appl. No.: 13/907,982

(22) Filed: Jun. 3, 2013

(51) Int. Cl. G01H 9/00

(52) U.S. Cl. CPC G01H 9/004
USPC 73/655

(57) ABSTRACT

A vibration detection system comprises a light source, a biconical tapered fiber comprising a biconical fiber taper and a detector is disclosed. The emission light emitted by the light source is directed to the biconical tapered fiber in one side. A detector is coupled to the other end of the biconical tapered fiber to measure the intensity of the light passing through. When the biconical tapered fiber is exposed to an external vibration, the biconical fiber taper deforms and modulates the light intensity accordingly. The received signal is then fed to the microcomputer to determine the amplitude and frequency of the external vibration. A method of vibration detection is also disclosed.

### FIELD OF INVENTION

This invention relates to a vibration detection system, and in particular a vibration detection system utilizing a biconical tapered fiber as the vibration sensor.

### BACKGROUND OF INVENTION

Traditional vibration sensors, such as magneto-electric, piezoelectric, and current sensors, are easily interfered by surrounding environment and electromagnetic waves. In order to deal with the aforesaid limitations, fiber optic vibration sensors are developed as alternative. Most fiber optic vibration sensors are based on interferometers or fiber Bragg gratings (FBGs). For interferometric sensors, they are susceptible to phase noise because of random fluctuations of fiber length mainly caused by temperature differences along the fiber. To reduce the effect of temperature and other low frequency environmental noise, a feedback loop circuit is usually used as a comparator to generate desired quadrature condition. For FBG-based sensors, the compensation of the temperature effect is also necessary due to the dependence of the Bragg wavelength on temperature. In addition, optical filter is an essential demodulation component for a FBG based vibration sensing system. For these two types of vibration sensors, either temperature compensation techniques or optical filter increases the complexity and cost of sensors.

### SUMMARY OF INVENTION

In the light of the foregoing background, it is an object of the present invention to provide a simple yet stable and robust fiber optic vibration sensor. In particular, the present invention discloses a vibration detection system utilizing a biconical tapered fiber as the vibration sensing module.

Accordingly, the present invention, in one aspect, is a vibration detection system which comprises a light source, a biconical tapered fiber and a detector. The light source generates an emission light which is directed to one end of the biconical tapered fiber. When an external vibration is applied to the biconical tapered fiber, it will deform accordingly and as a result modulating the intensity of the emission light passing through the fiber. The detector is coupled to the other end of the biconical tapered fiber and is configured to receive the emission light after passing through the biconical tapered fiber.

In one embodiment, the light source used in the present invention is a coherent light source. In another embodiment, the coherent light source is a laser source.

In an exemplary embodiment of the present invention, the biconical fiber taper used in the vibration detection system is a nonadiabatic fiber taper. In another embodiment, the biconical fiber taper is encapsulated within a quartz capillary.

In another embodiment, the vibration detection system further comprises a diaphragm, which is configured to transmit external vibration, coupled to the biconical tapered fiber.

In yet another exemplary embodiment, the vibration detection system further comprises a microcomputer configured to demodulate the received signal, thereby determining the amplitude and frequency of the external vibration.

According to another aspect of the present invention, a method of detecting vibration is disclosed. The method comprises the steps of directing a light wave into a biconical tapered fiber; placing the biconical tapered fiber in contact with a vibrating surface with the biconical fiber taper being suspended; wherein the vibration of the vibrating surface causes the biconical fiber taper to deform; receiving light wave that passes through the biconical tapered fiber; and analyzing the received signal to determine the vibration amplitude and frequency.

In an embodiment, the step of analyzing the received signal further comprises the step of determining the frequency spectrum of the received signal; and determining the amplitude and frequency of the first harmonic of the frequency spectrum.

There are many advantages to the present invention. In particular, the present invention provides a stable fiber optic vibration sensor without any complementary parts, for instance feedback control loop or optical filters. Such design reduces both the complexity and the cost of the system. Another advantage of the present invention is that there is no coherence requirement regarding the light source used in the present invention. Last but not least, the present invention is insensitivity to the surrounding temperature changes.

### BRIEF DESCRIPTION OF FIGURES

FIG. 1 is a schematic diagram of the vibration detection system according to one of the embodiment of the present invention.

FIGS. 2a, 2b and 2c are the longitudinal-sectional view of the fiber optic vibration sensor according to different embodiments of the present invention.

FIG. 3 is the flow chart of a method of detecting vibration according to one of the embodiment of the present invention.

FIG. 4 shows the planform of a fiber optic vibration sensor manufactured according to an embodiment of the present invention under optical microscopy.

FIG. 5a shows the received electrical signal when the vibration detection system is exposed to an acoustic vibration of 1 kHz. FIG. 5b shows the Fourier transform of the electrical signal as shown in FIG. 5a.

FIG. 6a shows the received electrical signal when the vibration detection system is exposed to an external vibration of 700 Hz with the biconical fiber taper encapsulated within a quartz capillary. FIG. 6b shows the Fourier transform of the electrical signal as shown in FIG. 6a.

FIG. 7a and FIG. 7b show the impulse response of the vibration sensor in time domain and frequency domain respectively.

### DETAILED DESCRIPTION OF THE PREFERRED EMBODIMENTS

As used herein and in the claims, “comprising” means including the following elements but not excluding others.

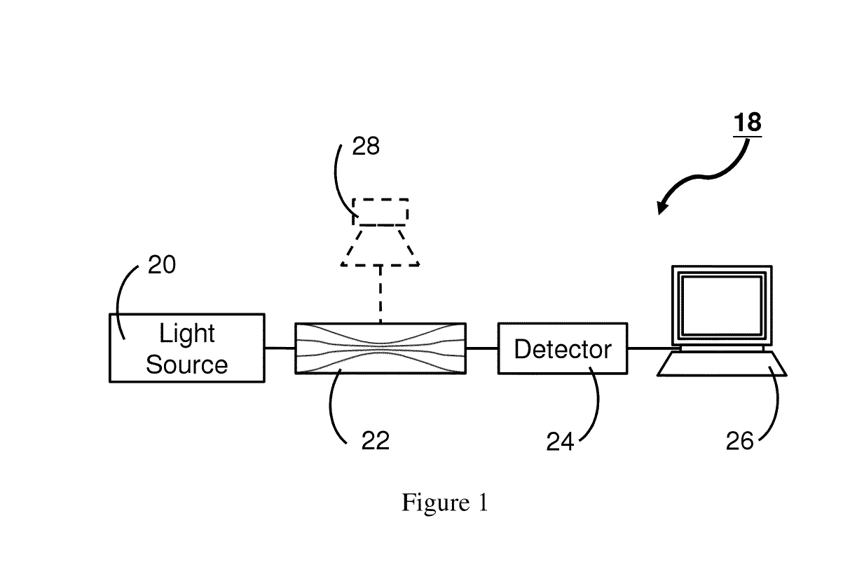

Referring now to FIG. 1, the first aspect of the present invention is a vibration detection system 18. The vibration detection system comprises a light source 20, a fiber optic vibration sensor 22, a detector 24 and a microcomputer 26. The emission light emitted by the light source 20 is directed to the fiber optic vibration sensor 22. A detector 24 is coupled to the other end of the fiber optic vibration sensor 22 to measure the intensity of the light passing through the fiber optic vibration sensor 22. The received signal is then fed to the microcomputer 26 to determine the amplitude and frequency of the external vibration 28. When the fiber optic vibration sensor 22 exposes to an external vibration 28, the tapered region of the fiber optic vibration sensor 22 deforms accordingly and in turn modulates the intensity of light passing through the fiber. In a specific embodiment, the fiber optic vibration sensor 22 is a nonadiabatic biconical tapered fiber.

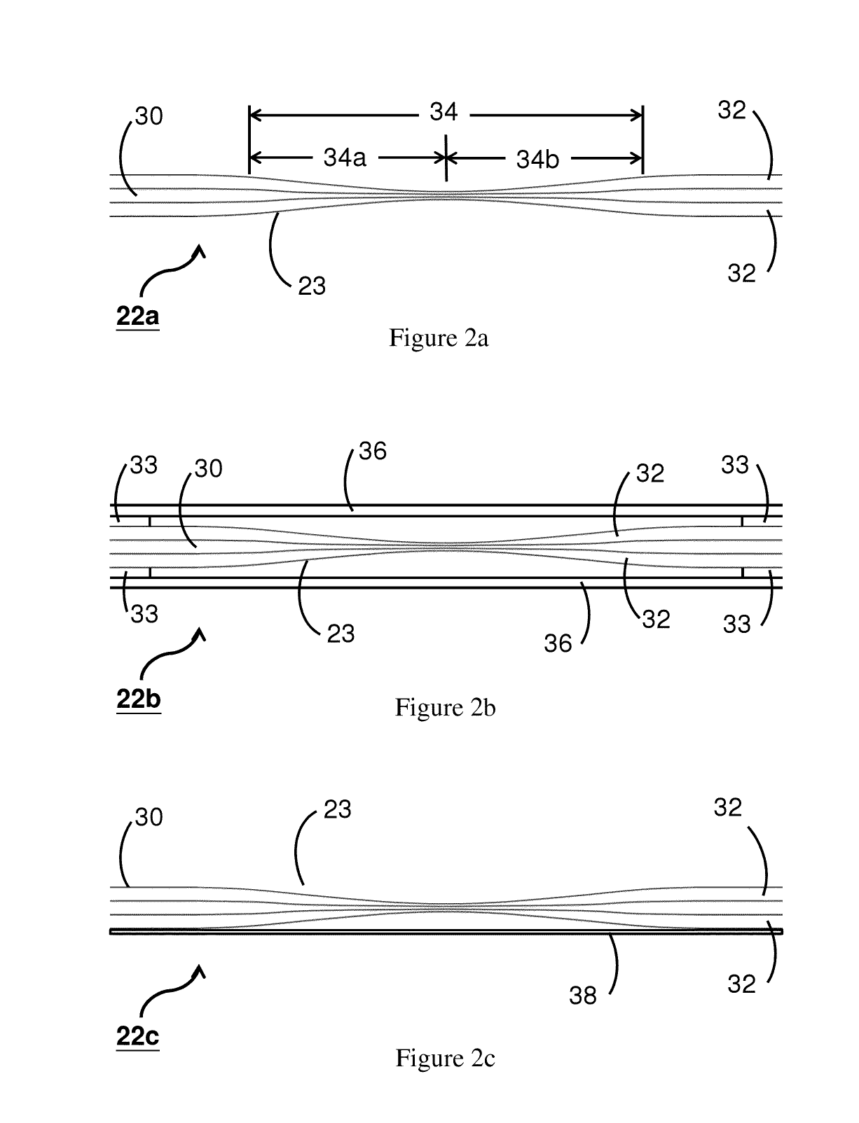

Referring now to FIGS. 2a, 2b and 2c, the longitudinal-sectional view of fiber optic vibration sensor 22 according to different embodiments of the present invention are shown. In one embodiment, the fiber optic vibration sensor 22 comprises a biconical tapered fiber 23. In one embodiment, the biconical tapered fiber 23 further comprises a biconical taper 34. In another embodiment, the biconical tapered fiber 23 is made of single-mode fiber (SMF). When the emission light is directed to the fiber optic vibration sensor 22, it propagates along the core 30 of the biconical tapered fiber 23. At the first half 34a of the biconical taper 34, fundamental mode of light propagating along the core 30 will be coupled to the cladding 32 of the biconical tapered fiber 23, thus exciting a plurality of the cladding modes due to the gradual decrease of the diameter of the biconical tapered fiber 23. When the light continues to propagate along the biconical tapered fiber 23, the diameter of the second half 34b of biconical taper 34 gradually increases. Due to the increase of the diameter, part of the cladding modes will be converted back to the fundamental mode whereas the remaining cladding modes will be lost in the way of energy loss. The energy loss will be governed by the geometry and movement of the biconical taper 34 of the biconical tapered fiber 23.

In a specific embodiment, as shown in FIG. 2a, the biconical taper 34 is suspended in the air. As such, the biconical taper 34 will be bended when the fiber optic vibration sensor 22a is placed in contact with a vibration surface which in turn alters the energy loss when light propagates through the fiber optic vibration sensor 22a.

In another embodiment of the present invention, as shown in FIG. 2b, the biconical tapered fiber 23 is encapsulated within a quartz capillary 36 to increase the durability of the vibration detection system 18. In one embodiment, the inner diameter of the quartz capillary 36 is the same as the diameter of the fiber jacket 33, thereby the biconical fiber taper is suspended in the air within the quartz capillary 36. When fiber optic vibration sensor 22b is placed in contact with the vibration surface, the quartz capillary 36 will not have significant deformation, but instead will move translationally with a varying acceleration. Consequently, the biconical tapered fiber 23 will bend within the quartz capillary 36 due to its inertia which in turn alters the amount of energy loss when light propagates through the fiber optic vibration sensor 22b.

In yet another embodiment, as shown in FIG. 2c, the fiber optic vibration sensor 22c further comprises a diaphragm 38. The diaphragm 38 is in contact with the biconical tapered fiber 23 at the corresponding biconical fiber taper of the biconical tapered fiber 23 suspended in the air. The benefit of including the diaphragm 38 is that the fiber optic vibration sensor 22c is able to detect vibration without physical contact with the vibration surface of the external vibration. In one embodiment, the vibration of interest is acoustic vibration. When acoustic waves hit the diaphragm 38, the diaphragm 38 transforms the acoustic waves into mechanical vibration. In other words, the diaphragm 38 acts as an internal vibration surface within the fiber optic vibration sensor 22c. In one embodiment, the diaphragm 38 is circular in shape so as to ensure that the acoustic wave induces symmetrical vibrations to the fiber optic vibration sensor 22c and results in a higher signal-to-noise ratio (SNR). In a further embodiment, the diaphragm 38 is made from aluminum.

In an embodiment of the present invention, the length of the biconical fiber taper of the fiber optic vibration sensor is within the range of 350 μm to 1500 μm. If the length is longer than the aforesaid range, the biconical fiber taper will tend to be an adiabatic one thereby reducing the sensitivity of the vibration detection system to the bending of the biconical fiber taper. On the other hand, if the biconical fiber taper is shorter than the aforesaid range, most of the light energy will be lost through the taper. Both scenarios result in a reduction of the SNR of the received signal by the detector.

In an embodiment of the present invention, the diameter of the narrowest region of the taper, which is also known as taper waist, is within the range of 10 μm to 30 μm. If the diameter of the taper waist is larger than the aforesaid range, light will mostly propagate in fundamental mode and thus reduces the sensitivity of the vibration detection system to the bending of the biconical fiber taper. On the other hand, if the diameter of the taper waist is smaller than the aforesaid range, the fiber optic vibration sensor may be easy to be broken when being installed.

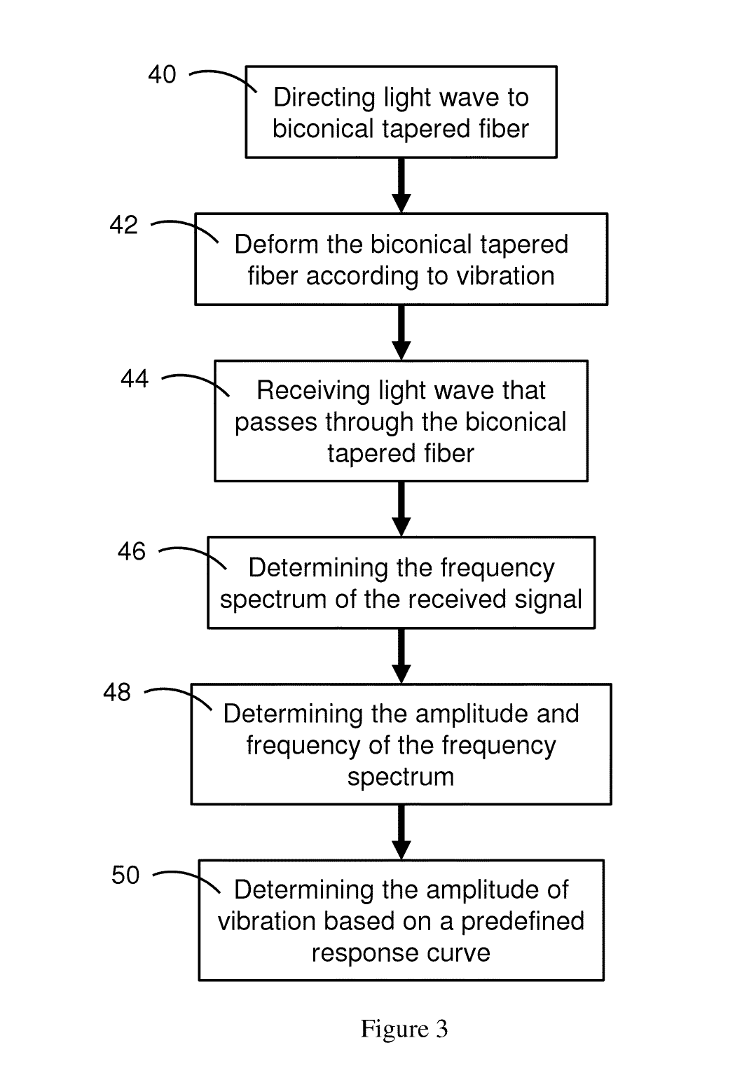

According to another aspect of the present invention, a method of detecting vibration is provided. Referring to FIG. 3, the first step 40 of the method is to direct a light wave to a biconical tapered fiber. The second step 42 is to deform biconical taper fiber according to the vibration of interest. The third step 44 is to record the light intensity which passes through the biconical tapered fiber and to convert to an electrical signal. The forth step 46 of the present invention is to determine the frequency spectrum of the electrical signal. The fifth step 48 is to determine the amplitude and frequency of the frequency spectrum. In one embodiment, the frequency of the first harmonic of the frequency spectrum, which is the actual frequency of the vibration of interest, is determined. In another embodiment, the relationship between the amplitude of the first harmonic of the frequency spectrum and that of the vibration of interest is non-linear. As such, an amplitude response curve is first obtained through a calibration process using vibration sources with known vibration amplitudes and frequencies. The method of detecting vibration further comprise a step 50 of determining the actual amplitude of the vibration of interest based on the measured amplitude of the frequency spectrum using the predefined response curves.

In a specific embodiment, Fast Fourier Transform (FFT) is applied in step 46. In another embodiment, step 42 further comprises the step of placing the biconical fiber taper in contact with a vibration surface of the vibration of interest with the biconical fiber taper being suspended.

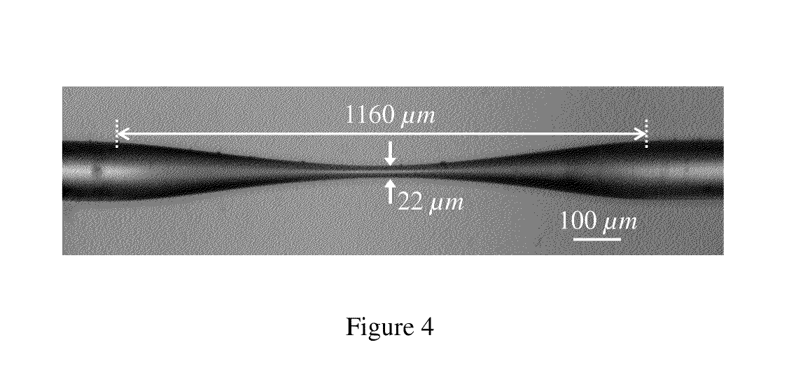

In order to demonstrate the flexibility of the present invention, a fiber optic vibration sensor was manufactured using a single-mode-fiber. In a specific implementation, the planform of the manufactured fiber optic vibration sensor in optical microscopy is shown in FIG. 4. The length of the biconical fiber taper and the diameter of the taper waist are 1160 μm and 22 μm respectively. The fiber optic vibration sensor further comprises a square metal diaphragm (not shown in the figure) with the dimension of 18.0 cm×14.6 cm×0.1 cm. A commercial speaker is used as an external vibration source placed underneath the metal plate. The light source used in this example is an amplified spontaneous emission light source with a wavelength range of 1540-1570 nm; whereas the detector used is an InGaAs photodetector. The detector is coupled with a data acquisition card to record the time domain light intensity signal without averaging. The received signal is then converted to a frequency spectrum using FFT algorithm.

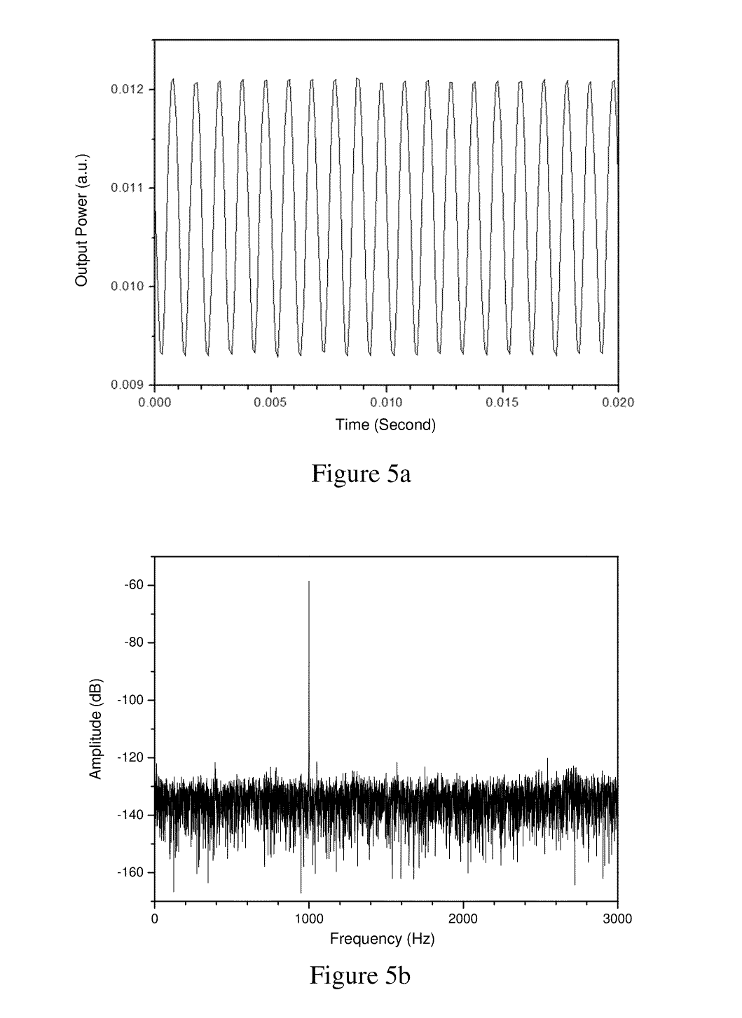

FIG. 5a shows received signal at the detector when the speaker is driven by a 1 kHz sinusoidal voltage waveform. FIG. 5b shows the corresponding frequency domain of the electrical signal as shown in FIG. 5a. The received signal at the detector is a sinusoidal waveform with substantially uniform amplitude and, as indicated in FIG. 5b, the frequency with the maximum amplitude is 1 kHz which is consistent with the driving frequency of the speaker. The SNR of the received signal is about 73 dB.

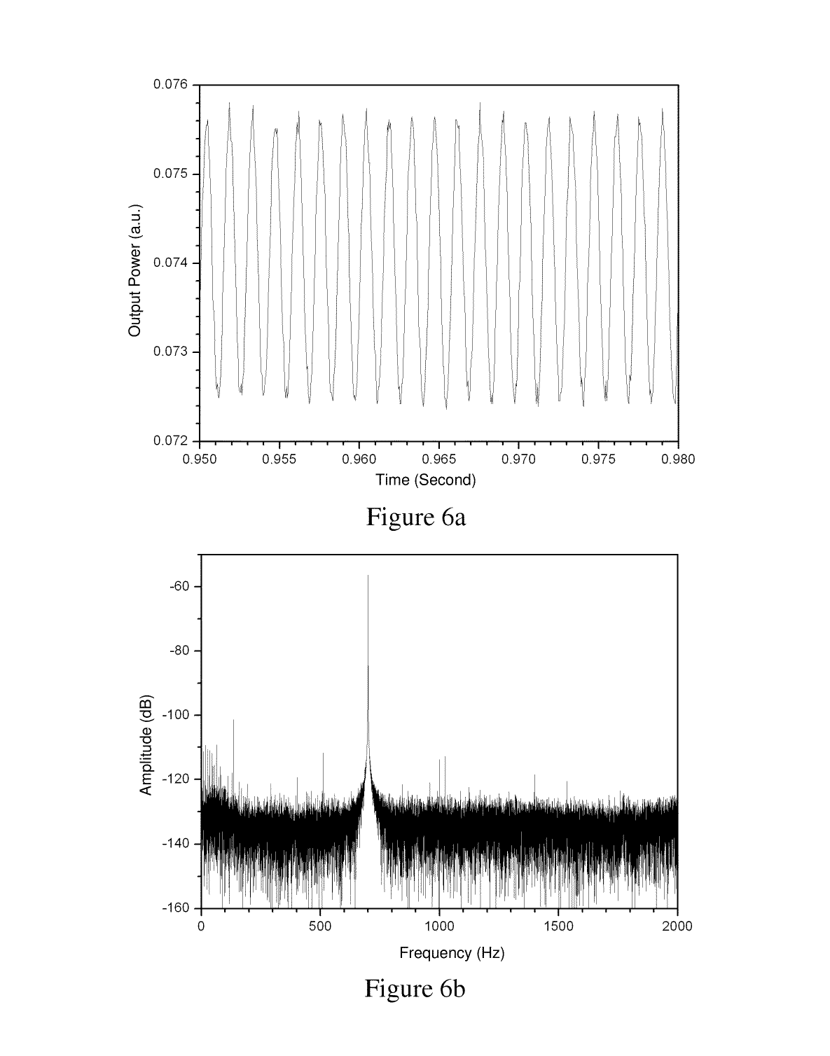

The experiment is repeated with the fiber optic vibration sensor encapsulated within a quartz capillary. In this experiment, a 700 Hz sinusoidal voltage waveform is applied to the speaker. FIGS. 6a and 6b show the detector received signal and the corresponding frequency spectrum obtained in this experiment respectively. The frequency with the maximum amplitude as indicated in FIG. 6b is 700 Hz which is also consistent with the driving frequency of the speaker. It should be noted that the SNR of the received signal decrease slightly when comparing with the previous experiment (as shown in FIGS. 5a and 5b). However, encapsulating the vibration sensor can increase the durability of the sensor, and at the same time prevents environmental dust and humidity from affecting the vibration detection.

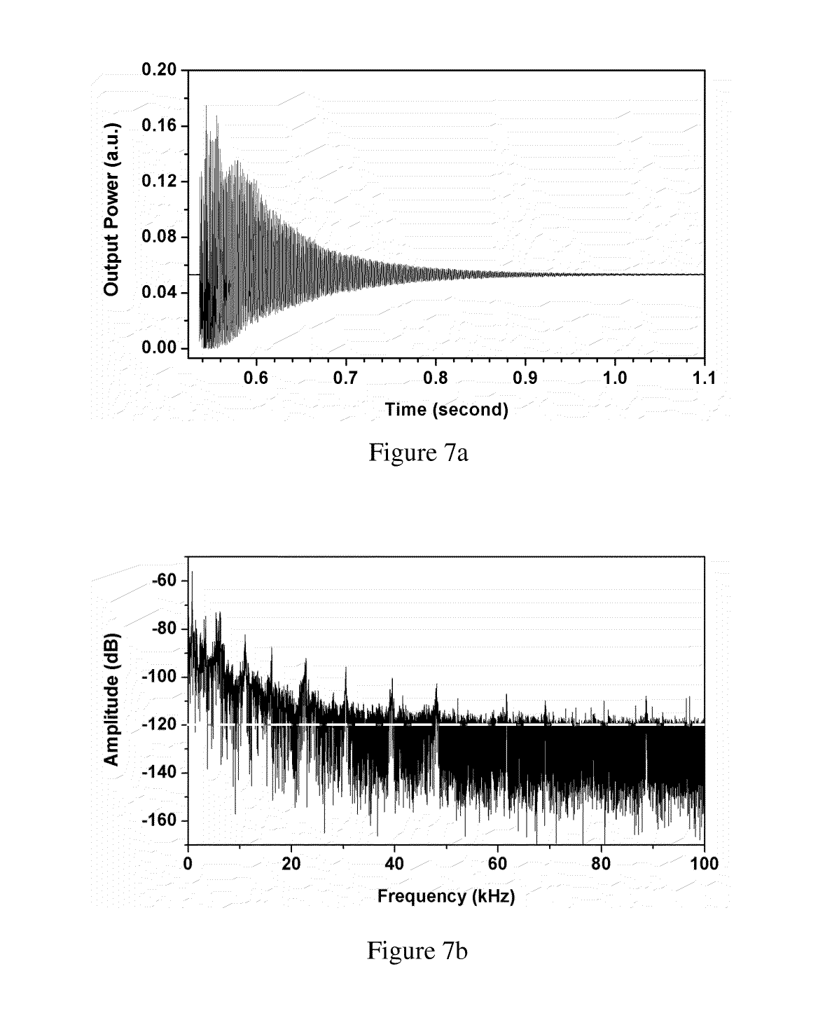

To further illustrate the flexibility of the present invention, the impulse (multiple-frequency) response of the fiber optic vibration sensor as shown in FIG. 4 is also studied. A hammer blow is applied to the metal plate at a region close to the taper waist. The detector received signal and the corresponding frequency spectrum are shown in FIG. 7a and FIG. 7b respectively. A damped oscillation can be observed clearly in FIG. 7a. In FIG. 7b, the white dotted line indicates the background level and it indicates that the fiber optic vibration sensor is capable of detecting vibration ranging from just a few hertz up to nearly 100 kHz.

The temperature effect on the fiber optic vibration sensor is also studied. The whole fiber sensor including the metal plate is put into a freezer. After the temperature dropped to about −20° C., the fiber optic vibration sensor is taken out. Then the fiber optic vibration sensor is tested immediately with the temperature gradually increase back to the room temperature. With the driving frequency of 1 kHz, all the measured vibration frequencies agreed with the driving frequency. The SNR of the received signal varied within ±1 dB around 72 dB while the temperature of the fiber optic vibration sensor varies almost 40° C.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the shape of the diaphragm is described as circular in FIG. 2c above, but it is clear that other shapes may be used according to the user's preference, such as oval, square, rectangular in shape. Furthermore the diaphragm can be made of other materials, for instance rubber and paper. On the other hand, quartz capillary is used to encapsulate the fiber optic vibration sensor. It is clearly that other packing method and corresponding material, for instance metal and plastic, can be applied.

A coherent light source is used in the aforesaid examples. However, a broadband light source can also be adopted in the present invention.

Fast Fourier transform is applied in the aforesaid examples to determine the frequency spectrum of the received signal. Nonetheless, it should be clear to one skill in art that other frequency transform algorithm can be applied in the method as proposed in the present invention.

Furthermore, though acoustic vibration picked up by a diaphragm is used to demonstrate how the system operates; the inventive ideas disclosed here can be used to measure other kinds of vibrations, as long as the vibration can be coupled to the fiber optic vibration sensor by a suitable transducer.

What is claimed is:

1. A vibration detection system comprising
a) a light source configured to generate an emission light;
b) a biconical fiber taper coupled to said light source; wherein said biconical fiber taper is configured for said emission light to propagate; and
c) a detector configured to receive said emission light passing through said biconical fiber taper and convert it to an electrical signal;
wherein an external vibration causes said biconical fiber taper to deform, thereby modulating the intensity of said emission light passing through said biconical tapered fiber.

2. The vibration detection system according to claim 1, wherein said light source is a coherent light source.

3. The vibration detection system according to claim 1, wherein said biconical fiber taper is nonadiabatic.

4. The vibration detection system according to claim 1, wherein said biconical fiber taper is encapsulated within a quartz capillary with the said biconical fiber taper being suspended.

5. The vibration detection system according to claim 1, wherein the taper length and the waist diameter of said biconical fiber taper are in the range of 350 μm to 1500 μm and 10 μm to 30 μm respectively.

6. The vibration detection system according to claim 1 further comprises a diaphragm coupled to said biconical tapered fiber; thereby transmitting said external vibration to said biconical fiber taper when a vibration wave hits said diaphragm.

7. The vibration detection system according to claim 6, wherein said diaphragm is in contact with said biconical fiber taper with said biconical fiber taper being suspended.

8. The vibration detection system according to claim 6, wherein said vibration wave is an acoustic wave.

9. The vibration detection system according to claim 6, wherein said diaphragm is a circular thin film made from materials selected from the group consisting of aluminum, rubber and paper.

10. The vibration detection system according to claim 1 further comprises a microcomputer coupled to said detector; wherein said microcomputer is configured to analyze said electrical signal, thereby determining the amplitude and frequency of said vibration.

11. A method of detecting vibration comprising the steps of:
a) directing a light wave into a biconical tapered fiber;
b) deforming said biconical fiber taper according to an external vibration;
c) receiving said light wave that passes through said biconical tapered fiber; and
d) analyzing the received signal to determine the amplitude and frequency of said external vibration.

12. The method of detecting vibration according to claim 11, wherein said step of analyzing said received signal further comprises the step of:
a) determining the frequency spectrum of said received signal; and
b) determining the amplitude and frequency of the first harmonic of said frequency spectrum;
wherein said amplitude and frequency of said first harmonic corresponds to said vibration amplitude and frequency of said external vibration.

13. The method of detecting vibration according to claim 12 further comprises the step of:
a) obtaining an amplitude response curve and a frequency response curve through a calibration process using vibration sources with predefined vibration amplitudes and frequencies; and
b) determining said vibration amplitude and frequency of said external vibration by matching said amplitude and frequency with said amplitude response curve and said frequency response curve respectively.
